(19) United States
(12) Patent Application Publication
(10) Pub. No.: US 2017/0296936 A1
(43) Pub. Date: Oct. 19, 2017

(54) Jewelry Box Gag Gift

(71) Applicant: Edward Peter Moffett, JR., Simi Valley, CA (US)

(72) Inventor: Edward Peter Moffett, JR., Simi Valley, CA (US)

(21) Appl. No.: 15/490,884

(22) Filed: Apr. 18, 2017

Related U.S. Application Data
(63) Continuation of application No. 62/323,799, filed on Apr. 18, 2016.

(51) Int. Cl. A63H 3/36; G06F 3/16; A63H 3/28; H04R 1/02; A63H 3/00

(52) U.S. Cl. CPC A63H 3/36; H04R 1/028; A63H 3/001; A63H 3/28; G06F 3/165

(57) ABSTRACT

A gift that includes a box, which presents a humorous or thoughtful interplay between the box and the contents within the box. Instead of jewelry, the box contains a figurine that resembles a person, pulling down his or her pants to expose his or her nude posterior. The box also contains a speaker that audibly presents the sound of a flatulent when the box is opened.

### BACKGROUND

Jewelry boxes typically contain jewelry and when given as a gift, elicit a favorable response from the recipient. The most common example exists in the typical proposal of marriage, wherein a man kneels before a woman, and presents to her a small box containing a diamond ring. He then asks, “Will you marry me?” The woman opens the box, begins to cry tears of joy and most often responds favorably to the proposal. Upon witnessing these “proposals,” in film and occasionally in public, I often thought, “What if the box contained something other than a ring—something offensive perhaps? Wouldn't that be a wonderful sight to behold? How would she respond?” So, I decided there was only one way to find out. This invention answers that question.

### DESCRIPTION OF RELATED ART

Aspects of the invention include the combination of known devices to create an entirely new device. Jewelry boxes, audio speakers and recording/playback devices obviously exist, but have never been configured and combined to produce a “gag gift,” such as the invention described herein.

### BRIEF SUMMARY OF THE INVENTION

The following is intended to be a brief summary of the invention and is not intended to limit the scope of the invention.

A ring box containing a model of a nude human posterior, an audio speaker, and an electronic recording/playback device.

The human posterior contained within the ring box faces outwards so as to show the complete gluteus maximus or “moon” to the opener of the box.

The audio speaker contained within the ring box is attached to the electronic recording/playback device, also contained within the ring box.

The electronic recording/playback device contained within the ring box holds in memory an audio recording of a human flatulent, or sound that closely resembles that of a flatulent.

The recording/playback device contained within the ring box is triggered when the box is opened.

Upon being triggered, the audio recording of the human flatulent is played through the speaker that is also contained within the ring box.

Closing the ring box resets the recording/playback device so that the sound may be played again from the beginning each time the box is opened.

### BRIEF DESCRIPTION OF THE DRAWING

FIG. 1. FIG. 1 shows one example of the physical structure of the first working prototype of the invention. The basic components shown are 1. Top of ring box, 2. Model of human posterior, 3. Mechanism for triggering audio/playback device upon opening the box, 4. Platform on which model of human posterior rests, 5. Bottom of ring box, 6. Location of audio recording/playback device and speaker.

### DETAILED DESCRIPTION OF THE INVENTION

The invention, intended to be given as a gift, is designed to elicit a laugh or possibly anger from the recipient. The concept of giving someone a ring box is widely accepted as a gesture of love or commitment, but this invention repurposes the ringbox to jest or offend, by replacing the normally expected contents (a ring), with a model of a human posterior that “farts” in the face of whomever opens the box.

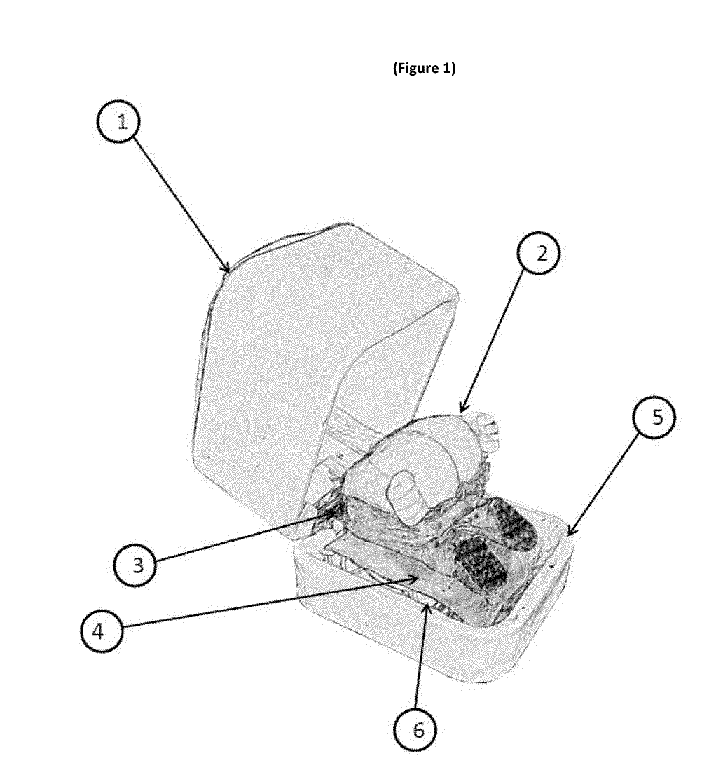

The ring box, comprised of a top, that is hinged to a bottom portion of the same width and depth, but significantly shorter in height is shown in FIGS. 1 at #1 and #5.

The model of a human posterior that is revealed upon opening the box is shown in FIG. 1 at #2. It sits atop a small platform (#4) which covers the speaker and audio recording/playback device contained within the bottom of the ring box.

The audio recording/playback device is triggered by a mechanism (#3) that connects from within the bottom of the box, to the top of the box, along the back side where the hinge is located. Because the connection runs along the two moving parts of the box, the act of raising the top of the box, moves the connecting piece in such a way as to trigger the recording/playback device located in the bottom of the box.

When triggered by the act of opening the top of the ring box, the audio recording/playback device emits the recorded sound of a flatulent through the speaker, thereby mimicking a human posterior that is expelling gas.

The ring box can be closed to silence the audio recording/playback device, and restart the sound of the flatulent from the beginning.

### Methods of Use

The invention is designed to be presented by one person to another with the intent of prompting laughter. Though it could quite possibly could be used to offend someone, it is intended to be used by and given to anyone with a decent sense of humor. My grandfather would have given this to my grandmother and laughed his old human posterior off.

### Variations

The figurine could be replaced with any offensive or comical contents. Comparable ideas include: 1. A model of a hand with its middle finger extended, 2. A model of a human penis, 3. A model of feces, 4. Any other offensive imagery.

The sound of a flatulent could be replaced with any offensive or comical sound or insulting verbiage.

The audio recording/playback device and speaker could be contained within the top of the ring box instead of the bottom.

The audio recording/playback device and speaker could be contained within the model of the human posterior instead of the bottom of the ring box.

The audio recording/playback device could be powered by battery or by USB charging device that connects through the ring box.

The breadth of the present invention is not to be limited to the examples provided and/or the subject specification, but rather only by the scope of the claim language. Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summaries, Detailed Descriptions, etc.) be accorded special significance in describing the invention relative to another or the claims. Although the foregoing invention has been described in detail for purposes of clarity of understanding, it is contemplated that certain modifications may be practiced within the scope of the appended claims.

1. A gag gift comprising:
a box containing a figurine in the shape of a person with his or her pants pulled down to expose his or her naked posterior;

2. The gag gift of claim 1 further comprising a speaker or other audio presentation device contained within the box for providing an audible sound.

3. The gag gift of claim 1 wherein the opening of said box of claim 1, activates playback of the audio sound of claim 2.
